(19) United States
(12) Patent Application Publication
(10) Pub. No.: US 2016/0210694 A1
(43) Pub. Date: Jul. 21, 2016

(54) METHOD AND APPARATUS FOR GENERATING TRADE ACTIONS TO MANAGE FINANCIAL RISK, AND RECORDING MEDIUM STORING PROGRAM FOR EXECUTING METHOD

(71) Applicant: Carl Jung Choon IM, Seoul (KR)

(72) Inventor: Carl Jung Choon IM, Seoul (KR)

(21) Appl. No.: 14/915,118

(22) PCT Filed: Aug. 28, 2014
(86) PCT No.: PCT/KR2014/008015

§ 371 Date: Feb. 26, 2016

(30) Foreign Application Priority Data
Aug. 30, 2013 (KR) 10-2013-0103768
Jan. 6, 2014 (KR) 10-2014-0001458

(51) Int. Cl. G06Q 40/04

(52) U.S. Cl. CPC G06Q 40/04

(57) ABSTRACT

The present invention relates to a method and an apparatus for generating trade actions to manage a financial risk, and a recording medium storing a program for executing the method. Provided are a method and an apparatus for generating trade actions, including a sell, a purchase, a hold and the timing of such trade action and the notional amount of trade, and a recording medium storing a program for executing the method. If financial risk management policies, including, but not limited to, a risk management policy for financial statements and a current foreign exchange and a risk management policy for raw material price fluctuation, are inputted, the present invention enables derivation of a more suitable financial management policy by examining the inputted financial risk management policies through simulation. If the more suitable financial risk management policy is derived, objective and systematic trade actions are generated on the basis of the derived financial risk management policy.

### TECHNICAL FIELD

The present invention relates to a method and apparatus for generating trade actions for a hands-on worker of an enterprise to objectively and systematically manage, among others, a financial risk including any foreign exchange risk, financing cost, and a raw material price fluctuation risk, and a recording medium which is able to store a program to execute the method.

### BACKGROUND ART

In general, enterprises are trying to reduce any financial market risk (FMR) using various management techniques, which includes any foreign exchange risk, an interest rate, stocks, a credit ratings, a raw material price fluctuation risk, etc. which have an effect on a cash flow, a net income and an enterprise value.

It is almost impossible for an executive of an enterprise to expect a stable and efficient enterprise activity under an unprotected situation without any countermeasure with respect to a potential risk in terms of a management, for example, any foreign exchange rate, a raw material price, etc.

In particular, most of small and medium-sized export and import enterprises are not managing any financial risk, but are well recognizing the necessity for the financial risk management. In this regard, they are subjectively judging and managing a trade action including a sell, a purchase, a trade amount, a trade time, etc.

Even the enterprises which have recognized the necessity for the financial risk management might have the following problems obtaining a good way to manage such a financial risk.

First, some of the enterprises including large companies are using hedge products that banks are providing so as to systemize unprofessional and subjective judgments. However, the limitations and potential dangers of above-mentioned method has been illustrated in the following cases, for example, Gibson's Greeting Card case which took place in 1994 in the USA, Proctor & Gamble case which took place in 1996 in the USA, Chunghwa Telecom case which took place in 2007 in Taiwan, Citic Pacific case which took place in 2008 in Hong Kong, and KIKO (Knock-In Knock-out) Case which took place in 2007 in Korea.

Second, even though the portion of the export in the total sale amount accounts for 100% in many enterprises, such enterprises are not big enough to apply a financial risk management expert, and it is actually hard to provide an appropriate means to manage a financial risk, for example, a financial risk management system.

For large enterprises and small and medium-sized enterprises, the financial risk management is a necessary element for the sake of a stable enterprise management since enterprise activities are being globalized, and exchange freedom and financial internationalization are greatly advancing.

The conventional systems and studies are focused on risk reporting only.

Most of the enterprises have the conventional financial management system, but they are using them on a subjective basis and without analyzing in depth the management technique proposed by the banks when it needs to judge when, how and how much the exchange or raw material price should be managed.

For this reason, the conventional technology has the problems below.

First, the KIKO case could occur since the enterprises are dependent on the external proposals, and the enterprise does not have a well thought out foreign exchange rate risk or raw material cost management policy, the enterprises tend to interest in the information which could be used for speculation, for which the trade actions of the enterprises may be changed to speculative in style.

Second, the conventional financial risk report system is focused on reporting the size of the risk at hand, and not suggesting an actual knowledge, information and countermeasure plan. The reason why the conventional financial risk report system is focused on the formal aspect is that each enterprise does not equip with any system to analyze and evaluate the financial risk management plan of each enterprise, and even though there is an analysis evaluation report, there is not any appropriate method that a hands-on worker and a manager can easily and objectively verify a corresponding report.

Third, it requires a financial risk management expert so as to actually use a financial risk management system or a front office system, for which an expensive cost is inevitable.

### DISCLOSURE OF INVENTION

Accordingly, the present invention is made in an effort to resolve the above problems. It is an object of the present invention to provide a method and apparatus for generating trade actions for a manager of an enterprise to objectively and systemically manage a financial risk in such a way to use a more appropriate financial management method, and a recording medium which is storing a program to execute the method, wherein each enterprise analyzes and develops a knowledge, information and countermeasure plan with respect to an innate exchange risk and a raw material price fluctuation risk of an enterprise, not depending on a bank or a product, and more specifically, a financial management policy of a corresponding enterprise can be reviewed and evaluated via a simulation so as to manage the financial risk of the enterprise, thus drawing the more appropriate financial management.

It is another object of the present invention to provide a method and apparatus for managing a financial risk which is able to generate a trade action, and a recording medium which is storing a program so as to execute the method, wherein any manager of a corresponding enterprise is able to automatically prepare a stylish and in-depth large enterprise-class report or a global standard report which is related with a financial risk management, and the prepared report can be easily verified.

It is further another object of the present invention to provide a method and apparatus for managing a financial risk which is providing a trade action, and a recording medium which is storing a program so as to execute the method, wherein even though the format in which accounting material is provided by different enterprises may vary, a user is able to easily and quickly obtain a desired material at a lower cost without carrying out an additional format conversion work.

To achieve the above objects, there is provided an apparatus for managing a financial risk providing a trade action, which may include, but is not limited to, a storing unit which is configured to store a smart data including accounting information, and an interrelationship information among the accounting information, and a plurality of risk management alternatives which are applied to the accounting information to generate a plurality of trade actions, which are in turn provided to set the obtaining of a profit and a loss in relation to each risk management alternative; statistical information calculation unit which is able to calculate statistical information on any of an exchange loss cost, a raw material purchase cost, a debt ratio and a cash holding amount which correspond to each risk management alternative among a plurality of the risk management alternatives in such a way to apply the smart data to a plurality of the risk management alternatives; a RMA (Risk Management Algorithm) selection unit which is configured to select, by using the statistical information, a risk management alternative which satisfies a condition wherein any of a maximum exchange loss cost, a maximum raw material purchase cost, a maximum debt ratio, and a minimum cash holding amount is within a predetermined range, and any of an average exchange loss cost, an average raw material purchase cost, an average debt ratio and an average cash holding amount is smallest; a trade action calculation unit which is able to calculate a trade action including at least one of a sell, a purchase, a hold, a trade time and amount in such a way to apply the smart data and a market information to the risk management alternative selected by the RMA selection unit; and a trade action execution unit which is able to execute a trade action by requesting to a financial institution server a process of the trade action calculated by the trade action calculation unit.

Preferably, there is further provided a risk trace unit which is configured to provide a risk trace information including a financial index corresponding to a predetermined value of a predetermined report when the value thereof is selected based on a calculation of the statistical information or the calculation of the trade action, an index name of a sub-financial index used to calculate the financial index, and an internal financial risk level, wherein the financial index is an accounting constant or a value calculated using the accounting constant.

Preferably, the trade action execution unit is configured to transmit to the financial institution server a contract information including a contract expiration date, a contract amount and a trade exchange, receive an exchange rate information on the trade exchange on the contract expiration date from the financial institution server, and request to the financial institution server a process of the trade action calculated by the trade action calculation unit with reference to the received exchange rate information.

Preferably, there is further provided a risk HD (High Definition) unit which is configured to calculate the value of a predetermined report using a representative financial index table stored in the storing unit and an interrelationship between the smart data if the predetermined report is selected, which is provided based on a calculation of the statistical information or a calculation of the trade action.

Preferably, the storing unit may include a hedge table which is provided to store the trade content information received from the financial institution server via the trade action execution unit; a planned position table which is provided to store an estimated financial statement information the amount and contract expiration date of which are uncertain; and an actual position table which is provided to store an actual financial statement information and amount, the kind of a maturity exchange the contract expirations of which are determined, and a standard financial statement information the contract expiration date is determined, which are among the estimated financial statement information stored in the planned position table.

Preferably, the financial risk management device further may include a table revolution unit wherein if the contract expiration date of the estimated financial statement information stored in the planned position table is determined, the information is converted into an actual financial statement information by assigning an ID to the estimated financial statement information, and the converted actual financial statement information is stored in the hedge table and the actual position table.

Preferably, there may be further provided a trade action review unit which is provided to calculate a simulated trade performance information by accumulating simulated loss and profit from the past to today based on a risk management alternative selected by the RMA selection unit, calculate an actual trade performance information by accumulating actual loss and profit from the beginning of the year to today, and provide the calculated simulated trade performance information and actual trade performance information.

Preferably, a plurality of the risk management alternatives may include, but is not limited to, a first risk management alternative wherein all the dollars are purchased at an exchange rate on the very date of the maturity date; a second risk management alternative wherein all the dollars are purchased on a corresponding date of the exchange rate is out of a previously set range; and a third risk management alternative wherein all the dollars are purchased at an exchange rate on the very date on the borrowing date.

According to a second aspect of the present invention, there is provided a method for managing a financial risk providing a trade action, which may include, but is not limited to, a step wherein a smart data including an accounting constant information and an interrelationship information among the accounting information, and a plurality of risk management alternatives to take a profit or define a loss via a plurality of orders are saved; a step wherein statistical information on any of an exchange loss cost, a raw material purchase cost, a debt ratio and cash holding amount which correspond to each risk management alternative among a plurality of the risk management alternatives by applying the smart data to each of a plurality of the risk management alternatives; and a step wherein a risk management alternative is selected using the statistical information, which satisfies a condition wherein any of a maximum exchange loss cost, a maximum raw material purchase cost, a maximum debt ratio and a minimum cash holding amount among a plurality of the risk management alternatives is within a previously set range, and any of an average exchange loss cost, an average raw material purchase cost, an average debt ratio and an average cash holding amount is smallest; and a step wherein a trade action including at least one of a sell, a purchase, a hold, a trade time and amount is calculated by applying the smart data and a market information to the selected risk management alternative.

Preferably, after the step for calculating the trade action, there are further provided a step wherein a contract information including a contract expiration date, a contract amount and a trade exchange is transmitted to a financial institution server; a step wherein an exchange rate information on the trade exchange on the contract expiration date is received from the financial institution server; and a step wherein the trade action is executed by requesting a process of the calculated trade action to the financial institution server with reference to the received exchange rate information.

Preferably, after the step for calculating the trade action, there are further provided a step wherein a simulated trade performance information is calculated by accumulating simulated loss and profit from the past to today based on the selected risk management alternative, and an actual trade performance information is calculated by accumulating actual loss and profit from the beginning of the year to today; and a step wherein the calculated simulated trade performance information and the calculated actual trade performance information are provided.

### Advantageous Effects

The present invention provides a method and apparatus for managing a financial risk which is providing a trade action including a sell, a purchase, a hold, a trade time, amount, etc. and a recording medium which is storing a program to execute the method, wherein if a financial risk management policy including a financial statement, a current exchange risk management policy, and a raw material risk management policy is inputted, a corresponding financial risk management policy can be reviewed via a simulation, thus making it possible to formulate a more appropriate financial management policy. If a more appropriate financial risk management policy is selected, an objective and systematic trade action consistent with that policy can be generated automatically. In this way, it is possible to inform what action is necessary to manage an exclusive financial risk of a corresponding enterprise under any market situation and demonstrate why such a management policy is better than other policies.

In addition, the present invention provides a method and apparatus for managing a financial risk which is providing a trade action, and a recording medium which is storing a program to execute the method, wherein if the values of a predetermined report is selected by a user, a financial index corresponding to the selected values, an index name of a sub-financial index used to calculate the financial index, an index value, an information including an included financial risk level, namely, a risk trace information can be provided, whereupon a report of a management form related with a financial risk for an exchange risk and a raw material price fluctuation can be automatically made, not simply reporting any financial risk.

Moreover, the present invention can also provide a method and apparatus for managing a financial risk which is providing a trade action, and a recording medium which is storing a program to execute the method, wherein if a predetermined report is selected by a user, the values of the predetermined report can be calculated using a relationship information between a representative financial index table including an index name, a code and the kind of an exchange and a smart data, whereupon even though the accounting material formats of the enterprises are different, it is possible to obtain a material that a user wants to in an easier way and at a low cost without carrying out an additional format conversion procedure.

### BRIEF DESCRIPTION OF DRAWINGS

FIG. 1 is a view for describing a method for managing a financial risk which is providing a trade action according to an embodiment of the present invention.

FIG. 2 is a block diagram schematically illustrating a configuration of a system for managing a financial risk which is providing a trade action according to an embodiment of the present invention.

FIG. 3 is a block diagram illustrating a configuration of an apparatus for managing a financial risk which is providing a trade action according to an embodiment of the present invention.

FIG. 4 is a flow chart illustrating a method for managing a financial risk which is providing a trade action according to an embodiment of the present invention.

FIG. 5 is a view for describing a RMA according to an embodiment of the present invention.

FIG. 6 is a view illustrating a risk trace information which is provided if a predetermined value is selected from a plan report in FIG. 5.

FIG. 7 is a view illustrating a risk trace information which is provided if a predetermined content is selected from an evaluation report in FIG. 6.

FIG. 8 is a graph illustrating statistical information on an annual foreign exchange gain and loss which is an example of a market risk calculated by applying a smart data to a plurality of RMAs.

FIG. 9 is a view illustrating an execution report which shows a result of the calculation of a trade action according to an embodiment of the present invention.

FIG. 10 is a view illustrating a risk trace information which is provided if a predetermined value is selected from an execution report in FIG. 9.

FIGS. 11 to 13 are views for describing a method for providing a risk trace information according to the present invention.

FIGS. 14 and 15 are views for describing a natural hedge function of an apparatus for managing a financial risk according to the present invention.

FIGS. 16 to 18 are views for describing a method for calculating a simulated trade performance information and an actual trade performance information at a review stage.

### BEST MODES FOR CARRYING OUT THE INVENTION

The technical terms used throughout the specification are provided only to describe embodiments, not intended to limit the present invention. Moreover, unless otherwise stated, the technical terms used throughout the specification should be interpreted as meanings which can be in general understood by a person having ordinary skill in the art, and such terms should not be interpreted as too exaggerated or contracted meanings. If the technical terms used throughout the specification cannot accurately define or express the concepts of the present invention, they should be interpreted based on a principal that they could be substituted with technical terms that a person having ordinary skill in the art can easily understand. Moreover, the ordinary terms used in the specification should be interpreted as they are defined in the dictionary or according to the context, not interpreted as too contracted meanings.

Moreover, the expression of a single form used in the present invention should be interpreted as including an expression of multiple numbers unless such terms are clearly different according to the context. The terms, for example, “comprise” or “include” should not be interpreted as always including multiple components or multiple steps recited in the specification. A part of such components or steps may not be included or a predetermined component or step could be further included.

The suffixes “module” and “part” with respect to the components used in the specification are added or combined for the sake of easier understanding of the present invention. They don't have any distinguishable definitions for specific meaning or function.

The terms, for example, an ordinal number such as a first, a second, etc. used in the specification will be used to describe various components, but such components should be limited by the ordinal numbers. The terms are used only for the purpose of distinguishing them from other components. For example, a first component may be named a second component without departing from the scope of the right of the present invention, and in a similar way, a second component may be named a first component.

The preferred embodiments of the present invention will be described with reference to the accompanying drawings. The same or similar components will be given the same reference numbers irrespective of the drawing reference numbers, and the duplicating descriptions thereon will be omitted.

If it is judged that a detailed description on the known technology may make unclear the subject matters of the present invention during the descriptions of the present invention, the corresponding descriptions will be omitted. The accompanying drawings are provided for only easier understanding of the present invention, so they should be used to limit the concepts of the present invention.

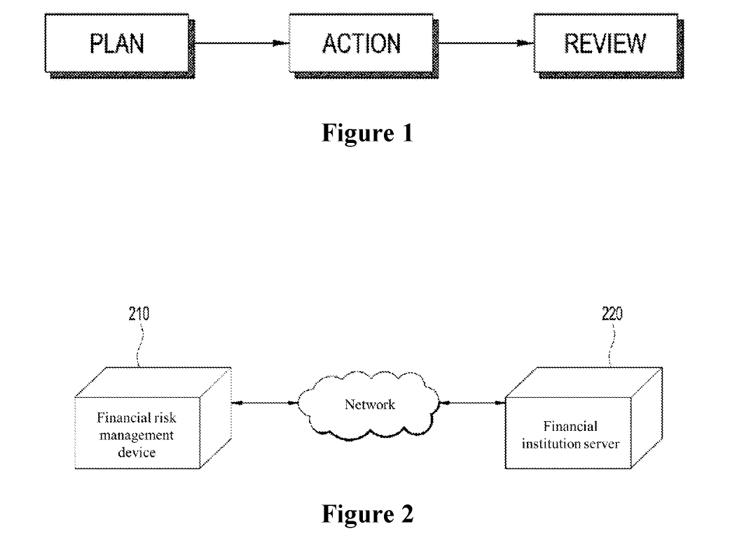

FIG. 1 is a view for describing a method for managing a financial risk which is providing a trade action according to an embodiment of the present invention.

Referring to FIG. 1, the method for managing a financial risk according to an embodiment of the present invention may include, but is not limited to, a plan step, an action step and a review step.

In the plan step, an accounting statement information including at least one among a gross production value, a gross sale prime cost, a sale cost and a management cost, a profit except for a business, a cost except for a business, a contract exchange rate, a business margin management target low limit, a business margin management target up limit and a contract amount; a smart data including an interrelationship information among the accounting information in the financial statement information; and a plurality of RMAs (Risk Management Algorithm) are stored. statistical information on After a statistical information has been calculated for, any of a foreign exchange gain-and-loss, a raw material purchase cost, a debt ratio and a cash holding ratio for each respective RMA, an RMA is selected, which satisfies a condition where any of a maximum exchange loss cost, a maximum raw material purchase cost, a maximum debt ratio and a minimum cash holding amount is within a predetermined set range, and any of an average exchange loss cost, an average raw material purchase cost, an average debt ratio and an average cash holding amount is smallest. Here, the RMA may be an algorithm so as to take a profit or define a loss through an ordinary order, a trailing stop order, a limit order, a stop-loss order, a take profit order, a one-cancels-other order, a call level and a buy or sell at close, etc. based on a market situation, for example, an exchange rate, a raw material price, etc. More specifically, the RMA may include, but is not limited to, a first RMA wherein all the dollars are purchased at an exchange rate on the very date of the settlement, a second RMA wherein all the dollars are purchased on a corresponding date if the exchange rate is out of a set range, and a third RMA wherein all the dollars are purchased at an exchange rate on the very date of the borrowing date.

In the execution step, a trade action, namely, a market trade action (hereinafter refereed to “MTA”) which includes a sell, a purchase, a hold, a trade time and amount, etc. is calculated in such a way that an interrelationship between an accounting statement information and an accounting constant information included in the financial statement information, and a market information are applied to the RMA selected in the plan step. Here, the market information may include at least one of an exchange rate, an interest rate and a raw material value.

In the execution step, a hedge contract information including a contract expiration date, a contract expiration date, a contract amount, a trade exchange, etc. is sent to a financial institution, and an exchange rate information including an actual trade price with respect to a hedge contract is received from the financial institution, and the processing, including but not limited to trade execution of the calculated MTA is requested to the financial institution with reference to the exchange rate information, thus receiving the trade execution details from the financial institution.

In the review step, the trade execution details information in the execution step is stored, and a simulated loss and profit is accumulated from the past to today based on the RMA selected in the plan step, thus calculating a simulated trade performance information, and the actual loss and profit are accumulated from the beginning of the year to today, thus calculating an actual trade performance information, and the simulated trade performance information and the actual trade performance information are made in the form of a graph and are provided together.

FIG. 2 is a block diagram schematically illustrating a configuration of a system for managing a financial risk which is providing a trade action according to an embodiment of the present invention.

Referring to FIG. 2, the system for managing a financial risk according to the present invention may include, but is not limited to a financial risk management device 210, and a financial institution server 220.

The financial risk management device 210 is configured to store a smart data formed of an interrelationship information (for example, a change relationship between an inventory amount and a sale amount) between a financial statement information and an accounting constant in the financial statement information, and a plurality of RMAs. Here, the financial risk management device 210 may store the smart data in the form of a spread sheet or may receive a smart data from the ERP server (not illustrated).

Moreover, the financial risk management device 210 will calculate a MTA including a sell, a purchase, a hold, a trade time and amount, etc. in such a way that statistical information on any of an exchange loss cost, a raw material purchase cost, a debt ratio and a cash holding amount which are annually provided for each RMA is calculated by applying the smart data to a plurality of RMAs, and a RMA is selected from a plurality of the RMAs, which satisfies a condition where any of a maximum exchange loss cost, a maximum raw material purchase cost, a maximum debt ratio and a minimum cash holding amount is within a previously set range, and any of an average exchange loss cost, an average raw material purchase cost, an average debt ratio and an average cash holding amount is smallest, and the market information including the smart data and the exchange trade are applied to the selected RMA. In this way, the manager is able to objectively and systematically execute the MTA in a manner consistent with the selected RMA.

Meanwhile, the financial risk management device 210 according to the present invention will send a contract information including a contract expiration date, a contract amount and a trade exchange to the financial institution server 220 after the MTA is calculated, and will receive a sell exchange information and a purchase exchange rate information on the trade exchange on the expiration date of the contract from the financial institution server 220. The financial risk management device 210 will request a process, including but not limited to trade execution, of the MTA to the financial institution server 220 with reference to the received exchange rate information.

Moreover, the financial risk management device 210 may provide a risk trace information including a financial index corresponding to the selected value, an index name of a sub-financial index used to calculate the financial index, an index value and an internal financial risk level if the value of a predetermined report is selected by a user (a manager of the enterprise) for the sake of a user's understanding and data verification with respect to various reports (for example, a risk map which is showing any exchange risks of the enterprise) provided based on the calculation of the statistical information, the calculation of the MTA and the review on the MTA. Here, the financial index may be s value which may be calculated using the accounting constants. The manager, therefore, can easily understand various reports while confirming the contents or procedure where the values were calculated and can verify the data on a corresponding report.

Moreover, the financial risk management device 210 will store a representative financial index table including an index name, a code and the kind of exchange and will calculate the values included in the predetermined report by using an interrelationship information of the representative financial index table and the smart data if the predetermined report is selected by the user. In this way, the financial risk management device 210 according to the present invention is able to calculate the necessary values without changing a conventional accounting material format, for which the user does not need to understand the information inside the smart data, and even though the accounting material formats of the enterprises are different, it is possible to obtain a desired material without carrying out an additional format conversion work.

Moreover, the financial risk management device 210 will accumulate the simulated loss and profit from the past to the today based on the selected RMA, thus calculating a simulated trade performance information, and will accumulate the actual loss and profit from the beginning of the year to the today, thus calculating an actual trade performance information and will provide the simulated trade performance information and the actual trade performance information together in the form of a graph.

The financial institution server 220 will receive from the financial risk management device 210 a contract information including a contract expiration date, a contract amount, and a trade exchange and will send to the financial risk management device 210 a sell exchange rate information and a purchase exchange rate information with respect to the trade exchange on the contract expiration date. Moreover, the financial institution server 220 will process the MTA if the process of the MTA calculated by the financial risk management device 210 is requested, and will send an information on a corresponding trade content information, namely, an information of a processed trade action to the financial risk management device 210.

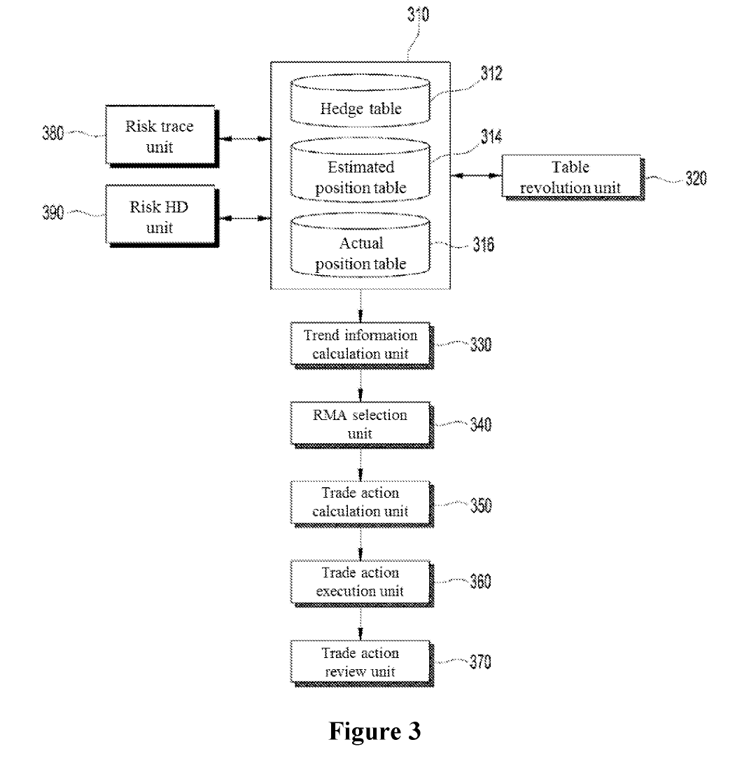

FIG. 3 is a block diagram illustrating a configuration of a financial risk management device which is providing a trade action according to an embodiment of the present invention.

Referring to FIG. 3, the financial risk management device 210 according to the present invention may include, but is not limited to, a storing unit 310, a table revolution unit 320, statistical information calculation unit 330, a RMA selection unit 340, a trade action calculation unit 350, a trade action execution unit 360, a trade action review unit 370, a risk trace unit 380 and a risk HD unit (Risk High Definition unit) 390.

The storing unit 310 is configured to store a smart data including an interrelationship information among parameters in the financial statement information, and a plurality of RMAs. Moreover, the storing unit 310 is able to store a representative financial index table including an index name, a code and the kind of exchange. The storing unit 310 may be formed of a hedge table 312, a planned position table 314, and an actual position table 316. The storing unit 310 may store a plurality of tables in addition to the above representative financial index tables and may be formed of a ROM, a RAM, an EEPROM, a HDD, a DVD, a cloud storage or a flash memory.

The hedge table 312 will store a trade content information received from the financial institution server 220 via the trade action execution unit 360. If the RMA requests an additional trade action, the trade action calculation unit 350 may draw a post-process trade action by adding a previous trade action to the market information with reference to the hedge table 312.

The planned position table 314 may store a financial statement information (hereinafter referred to “an estimated financial statement information”) which needs a plan since the amount, for example, an estimated sale amount and an estimated material cost, the contract expiration date and the settlement date are uncertain. Here, the estimated financial statement information may include, but is not limited to, a risk start data on which the exchange reference rate has been determined, a risk end data on which the Korean monetary unit value has been recorded on a ledger, and a PID (Plan-Identification), etc.

The actual position table 316 will store a financial statement information (hereinafter referred to “a standard financial statement information”) which does not need any plan since a financial statement information (hereinafter referred to “an actual financial statement information”) for which the amount, the kind of exchange, a contract expiration date and a settlement date among the estimated financial statement information stored in the planned position table 314, and the amount and the contract expiration date, for example, the borrowed money and deposit and withdrawal are certain. Here, the actual financial statement information may include a risk start date on which an exchange reference rate has been determined, a risk end date on which the Korean monetary unit value has been recorded on the ledger, a contract fixing date on which the amount and the settlement date have been determined, a settlement date on which the contract amount will be deposited, a PID and an ID (Identification). Moreover, the standard financial statement information may include an ID.

The table revolution unit 320 will add an ID to an estimated financial statement information if the contract expiration date of the estimated financial statement information stored in the planned position table 314 is determined and will convert the estimated financial statement information into an actual financial statement information and will store it in the hedge table 312 and the actual position table 316.

The statistical information calculation unit 330 will calculate statistical information on any of an exchange loss cost, a raw material purchase cost, a debt ratio and a cash holding amount which are provided on an annual basis for each RAM, in such a way to apply the smart data to a plurality of RMAs. In the present invention, the statistical information calculation unit 330 is limited to calculating the statistical information on any of an exchange loss cost, a raw material purchase cost, a debt ratio and a cash holding amount which are provided on an annual basis for each RAM, but it is not limited thereto. The statistical information calculation unit 330 may calculate statistical information on a financial risk which has an effect on the value of the enterprise including an exchange loss cost, a raw material purchase cost, a debt ratio and a cash holding amount, which are provided on annual, weekly, monthly or long term basis.

The RMA selection unit 340 may select a RMA among a plurality of the RMAS, which satisfies a condition wherein any of a maximum exchange loss cost, a maximum raw material purchase cost, a maximum debt ratio and a minimum cash holding amount is within a previously set range, and any of an average exchange loss cost, an average raw material purchase cost, an average debt ratio and an average cash holding amount is smallest. Here, the RMA selection unit 340 will select a RMA for each financial statement information in such a way to classify an estimated financial statement information, an actual financial statement information and a standard financial statement information by using a PID and an ID included in the financial statement information. Here, the RMA corresponding to the estimated financial statement information is a pre-hedge RMA, and the RMA corresponding to the actual financial statement information and the standard financial statement information is a hedge RMA.

The trade action calculation unit 350 will calculate a MTA including a sell, a purchase, a hold, a trade time and amount by applying the smart data and market information to the RMA selection part 340. The trade action calculation unit 350 will calculate a MTA by applying the pre-hedge RMA with respect to the estimated financial statement information the contract date of which is ahead based on the date of today and will calculate the MTA by applying the hedge RMA with respect to the standard financial statement information which does not need any actual financial statement information and plan the contract date of which have arrived.

In this way, the financial risk management device 210 according to the present invention is able to manage the financial statement information the contract expiration date of which is certain as well as the financial statement information the contract expiration date of which is uncertain.

Moreover, the trade action calculation unit 350 according to the present invention may provide a natural hedge function. The natural hedge is to offset a trade by netting the sell and purchase. In this way, the enterprise can save the trade cost.

The trade action execution unit 360 will transmit a contract information including a contract expiration date, a contract amount and a trade exchange to the financial institution server 220 after the MTA is calculated by the trade action calculation unit 350 and will receive an exchange rate information including an actual trade price (Live Price) on a trade exchange on the contract expiration date from the financial institution server 220 and will request a process of the calculated MTA to the financial institution server 220 with reference to the received exchange rate information. In this way, the trade action execution unit 360 will receive a corresponding trade content information from the financial institution server 220. Here, the trade action execution unit 360 may be formed of a wired or wireless communication means.

Moreover, the trade action review unit 370 will calculate a simulated trade performance information by accumulating the simulated loss and profit from the past to the beginning of the year based on the RMA selected by the RMA selection unit 340 and will calculate an actual trade performance information by accumulating the actual loss and profit from the beginning of the year to the today and will provide the simulated trade performance information and the actual trade performance information. Here, the trade action review unit 370 may provide the simulated trade performance information and the actual trade performance information in the form of a graph together.

If the value of a predetermined report is selected by the user, the risk trade unit 380 will provide a risk trace information including a financial index corresponding to the selected value, an index name of a sub-financial index used to calculate the financial index, an index value and an internal financial risk level.

If a predetermined report is selected by the user, the risk HD unit 390 will calculate the value of the predetermined report by using a representative financial index table and an interrelationship information between the smart data which are stored in the storing unit 310.

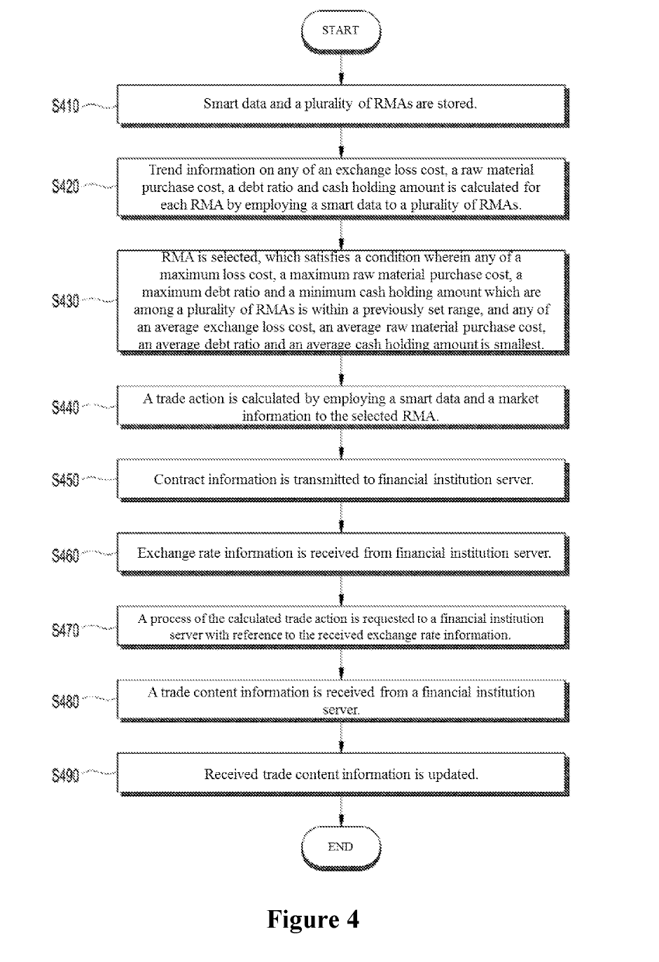

FIG. 4 is a flow chart for describing a method for managing an exchange to provide a trade action according to an embodiment of the present invention.

Referring to FIG. 4, the financial risk management device 210 will store a smart data including an interrelationship between a financial statement information and an accounting constant information in the financial statement information and a plurality of RMAs (S410). Here, the financial risk management device 210 may store a representative financial index table including an index name, a code and the kind of exchange, a hedge table, a planned position table and an actual position table.

The financial risk management device 210 will calculate an exchange loss cost, a raw material purchase cost, a debt ratio and a cash holding amount for each RMA in such a way to apply the smart data to a plurality of RMAs (S420). Here, the financial risk management device 210 may calculate statistical information with respect to the financial risk which may have an effect on the value of the enterprise including an exchange loss cost, a raw material purchase cost, a debt ratio and a cash holding amount on yearly, monthly, and weekly basis.

The financial risk management device 210 will select a RMA among a plurality of the RMAs, which satisfies a condition wherein any of a maximum exchange loss cost, a maximum raw material purchase cost, a maximum debt ratio and a minimum cash holding amount is within a previously set range, and any of an average exchange loss cost, an average raw material purchase cost, an average debt ratio and an average cash holding amount is smallest (S430).

Moreover, the financial risk management device 210 may calculate a MTA including a sell, a purchase, a hold, a trade and amount by applying the smart data and the market information to the selected RMA (S440).

The financial risk management device 210 will transmit to the financial institution server 220 a hedge contract information including a contract expiration date, a contract amount and trade exchange (S450) and will receive an exchange rate information including an actual trade price with respect to a hedge contract from the financial institution server 220 in response to the transmission (S460).

The financial risk management device 210 will request a process of the calculated MTA to the financial institution server 220 with reference to the exchange rate received from the financial institution server 220 (S470).

The financial risk management device 210 finally will receive a trade content information from the financial institution server 220 (S480) and will update the received trade content information (S490).

Meanwhile, the method for managing a financial risk according to the present invention may include, but is not limited to, a step wherein a simulated trade performance information is calculated in such a way that the simulated loss and profit from the past to the beginning of the year are accumulated based on the selected RMA, and an actual trade performance information is calculated by accumulating the actual loss and profit from the beginning of the year to the today, and a step wherein the calculated simulated trade performance and the calculated actual trade performance information are provided.

The above mentioned method may be carried out by various means. For example, the embodiments of the present invention may be carried out by a firmware, a software or a combination thereof.

In case that the method is carried out by the software, the method according to the embodiment of the present invention may be carried out by one of more of ASICs (Application Specific Integrated Circuits), DSPs (Digital Signal Processors), GPUs (Graphic Processor Units), DSPDs (Digital Signal Processing Devices), PLDs (Programmable Logic Devices), FPGAs (Field Programmable Gate Arrays), a processor, a controller, a micro controller and a microprocessor.

In case that the method is carried out by a firmware or a software, the method according to an embodiment of the present invention may be carried out in the form of a module, a procedure or a function which is able to carry out the above-described function or operation. The software code may be stored at the memory unit and may be driven by the processor. The memory unit may position inside or outside the processor and is able to communicate the data with the processor by various means.

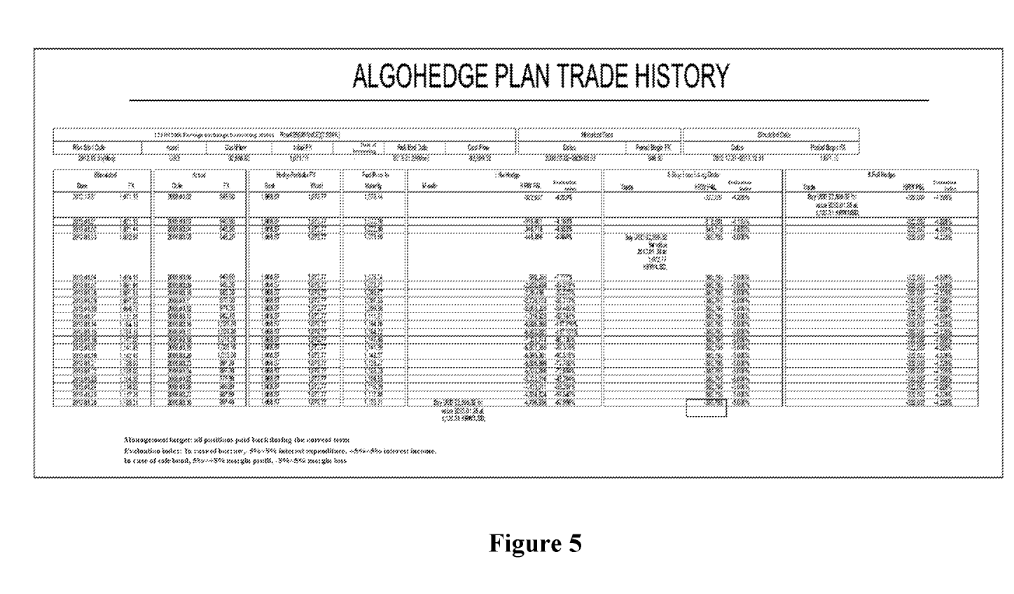

FIG. 5 is a view for describing a RMA according to an embodiment of the present invention.

Referring to FIG. 5, it shows that 92,688.50 dollars are borrowed on the risk start date by a predetermined enterprise, namely, on Dec. 31, 2012 which is the borrowing date, and 92,899,32 dollars are paid back on Jan. 28, 2013 which is the pay-back date.

The first RMA (1. No Hedge) means a RMA wherein the maturity is carried out at the exchange rate on the very date of the settlement date. Namely, according to the first RMA, if today is the last date, all the dollars are purchased. For example, as illustrated in FIG. 5, the dollars are purchased at 1120.31 dollars which are the market price on Jan. 28, 2013, and the borrowed money is paid back.

According to the second RMA (5. Stop loss using order), if the exchange rate of the row “Fwd price to Maturity) is higher than the exchange rate of the row “Hedge Portfolio FX Worst”, all the dollars are unconditionally purchased at the exchange rate of the row “Hedge Portfolio Fx Worst”. For example, as illustrated in FIG. 5, on Jan. 3, 013 on which the exchange rate of the row “Fwd price to Maturity” is higher than the exchange rate of the row “Hedge Portfolio FX worst”, the dollars are purchased at 1072.77 won which corresponds to the exchange rate of the row “Hedge Portfolio FX Worst” on Jan. 3, 2013, and the borrowed money is paid back on Jan. 28, 2013.

According to the third RMA (7. Full Hedge), if today is the first date, namely, if it is the very date of the borrowing date, all the dollars are unconditionally purchased at the exchange rate of “Fwd price to Maturity” of the first date. For example, as illustrated in FIG. 5, the dollars are purchased at 1072.14 won which corresponds to the market futures price (“Fwd price to Maturity) on Dec. 31, 2012 of the borrowing date, and the borrowed money is paid back on Jan. 28, 2013 which is the maturity date.

As described above, the RMA according to the present invention represents an algorithm so as to take a profit or define a loss through an ordinary order, a trailing stop order, a limit order, a stop-loss order, a take profit order, a one-cancels-other order, a call level and a buy or sell at close, etc. based on a market situation. In the present invention, the exchange rate has been described as an example of the market situation, but it is not limited thereto. The market situation may be a raw material price and a grain price.

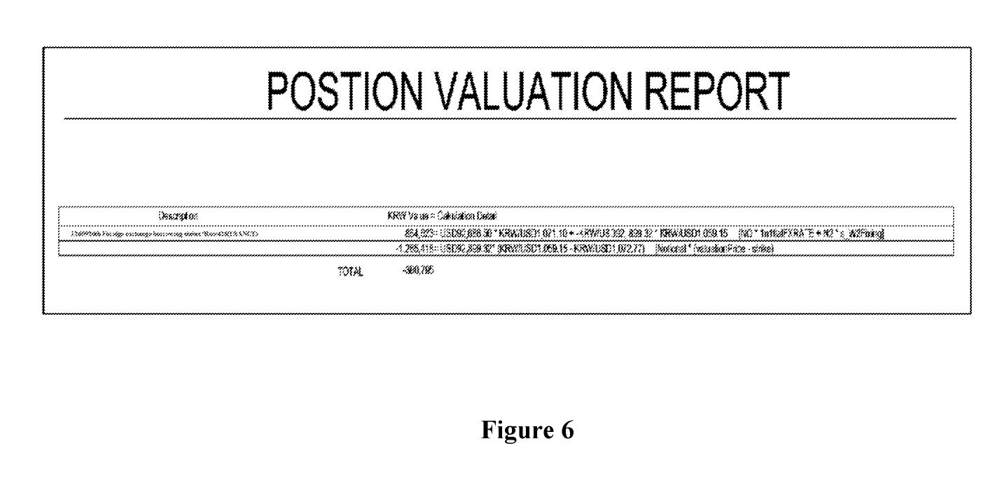

FIG. 6 is a view illustrating a risk trace information if a predetermined value is selected from a plan report in FIG. 5.

If the value (“−380,795” in FIG. 5) of the plan report is selected by the manager, as illustrated in FIG. 6, there may be provided a risk trace information including a description corresponding to the selected value, a Korean monetary unit value (KRW value), and a calculation detail.

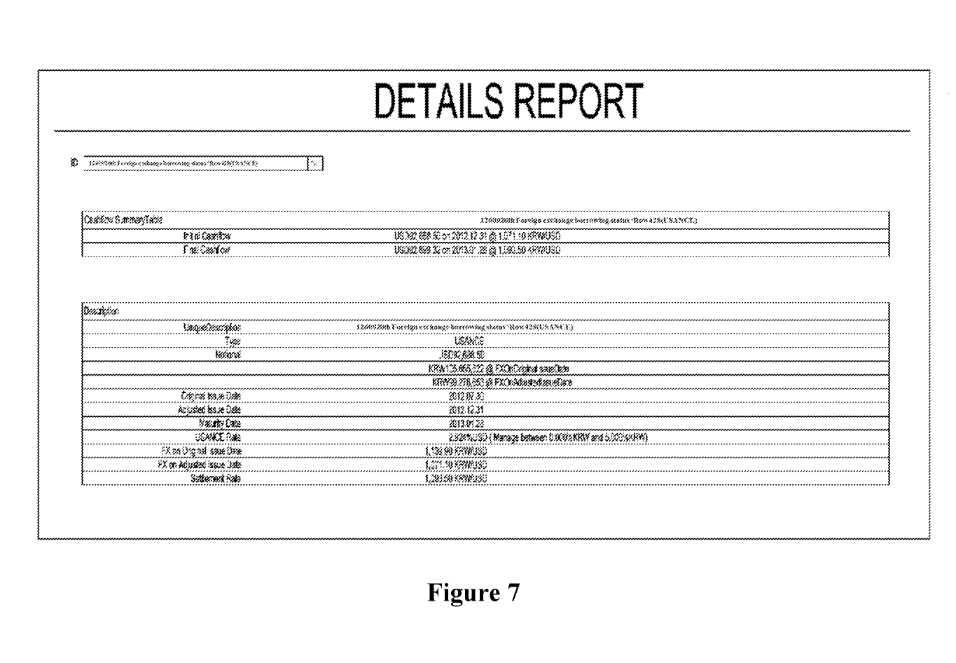

FIG. 7 is a view illustrating a risk trace information if a predetermined content is selected from the position evaluation report in FIG. 6.

If the contract name (“1260920th—foreign money borrowing status! Row 428”) of the position evaluation report is selected by the manager, as illustrated in FIG. 7, there will be provided a risk trace information including the type corresponding to the selected contract name, a notional amount, an original issue date, an adjusted issue date, a maturity date, a USANCE rate, a FX on an original issue date, a FX on an adjusted issue date, and a settlement rate.

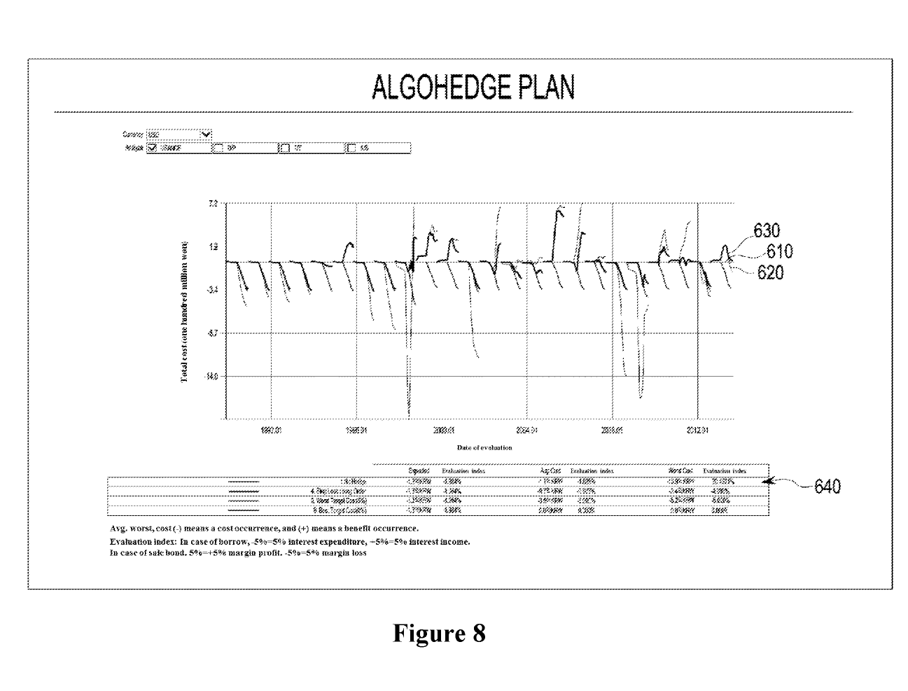

FIG. 8 is a graph illustrating statistical information with respect to an annual exchange loss cost, which is an example of a market risk calculated by applying a smart data to a plurality of RMAs.

According to the present invention, the statistical information will be calculated in such a way to apply the smart information to the first RMA (NO hedge) and the second RMA (Stop Using Order) in FIG. 8. Here, the first RMA means a RMA which does not do the hedge, and the second RMA means a RMA which does the hedge. The statistical information of the foreign exchange gain and loss means an information on the foreign exchange gain and loss corresponding to each time in a predetermined year.

For example, reference number 610 means a reference statistical information, and 620 means statistical information on an annual foreign exchange gain and loss calculated by applying the smart data to the first RMA, and 630 means statistical information on an annual foreign exchange gain and loss calculated by applying the smart data to the second RMA.

Referring to FIG. 8, the maximum foreign exchange gain and loss (worst cost) of the second RMA is smaller than the maximum foreign exchange gain and loss of the first RMA. Here, the maximum foreign exchange gain and loss means a biggest foreign exchange gain and loss in the statistical information on the annual foreign exchange gain and loss calculated by applying the smart data to each RMA.

For example, reference number 640 means a maximum foreign exchange gain and loss in the statistical information on the foreign exchange gain and loss for the past 13 years calculated by applying the smart data to the first RMA.

According to the present invention, the MTA including a sell, a purchase, a hold, a trade time and amount can be calculated in such a way to select the first RMA, the second RMA and the third RMA and to apply the mart data and market information to the second RMA.

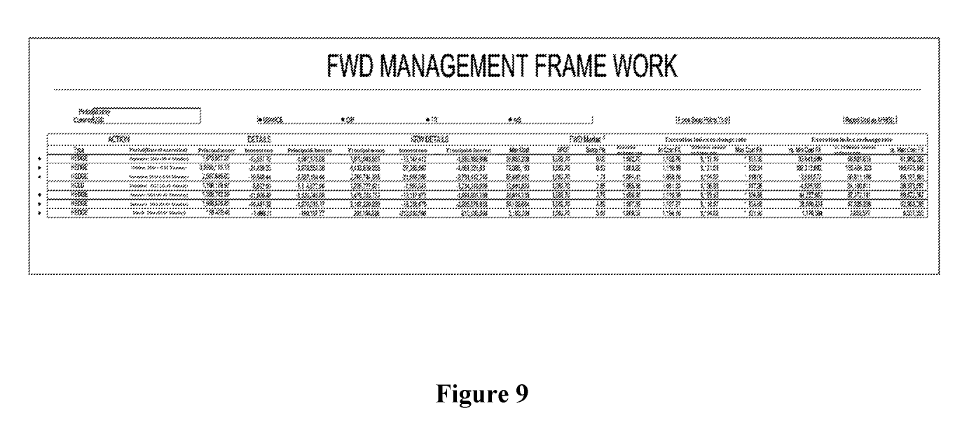

FIG. 9 is a view illustrating an execution report which is showing a result of the calculation of the trade action according to an embodiment of the present invention.

As illustrated in FIG. 9, the financial risk management device 210 according to the present invention will calculate the MTA including a sell, a purchase, a hold, a trade time and amount. More specifically, if the exchange rate of the row “FWD Market” is out of the range of the execution index exchange ratio, the MTA of the sell or purchase is provided. For example, in case of the borrowed money which will expire on September 2013, the exchange rate of the row “FWD Market” is 1,082.70, which is out of the range of 1,102.76-1,131.30 which is the execution index exchange rate, the hedge will be applied. Meanwhile, in case of the borrowed money which will expire in December, 2013, the exchange rate of the row “FWD Market” is 1,085.36, which is in the range of 1,081.03-1,117.98 which is the execution index exchange rate, the hold will be taken.

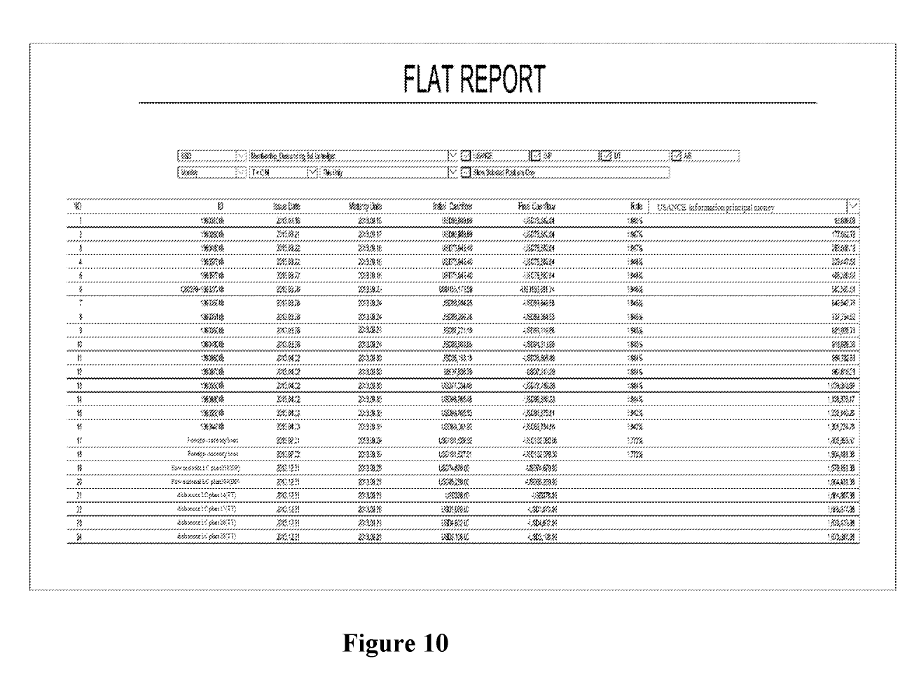

FIG. 10 is a view illustrating a risk trace information which will be provided in case where a predetermined value is selected from the execution report in FIG. 9.

Referring to FIGS. 9 and 10, if the value of the execution report is selected by the manager (“a principal money of 1,673,587.38”) is selected by the manager, as illustrated in FIG. 10, there will be provided an ID corresponding to the selected value, a borrowing date (an issue date), a maturity date, a borrowed money (an initial cash flow) and a maturity amount (a final cash flow).

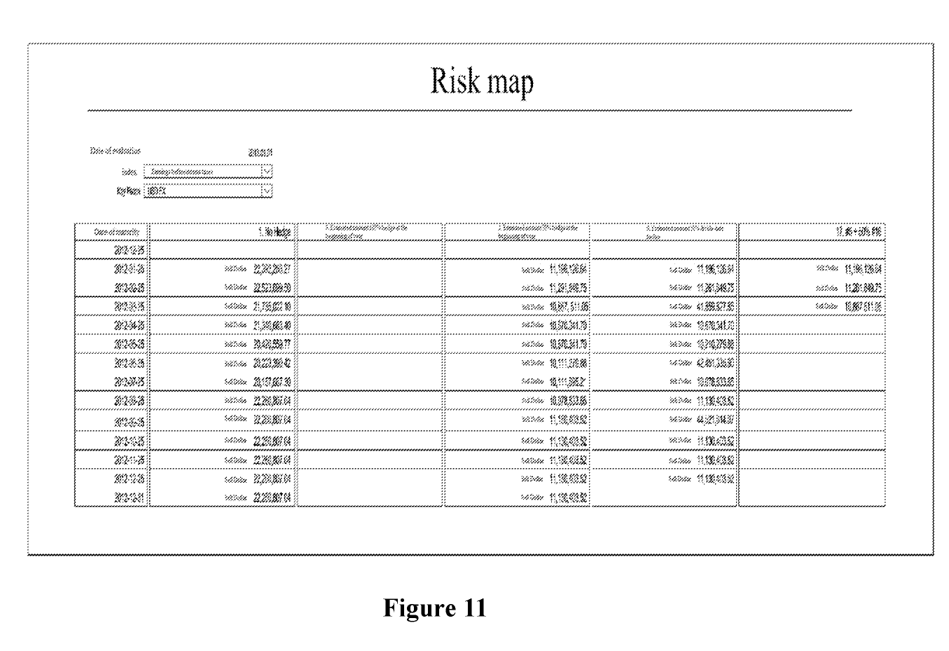

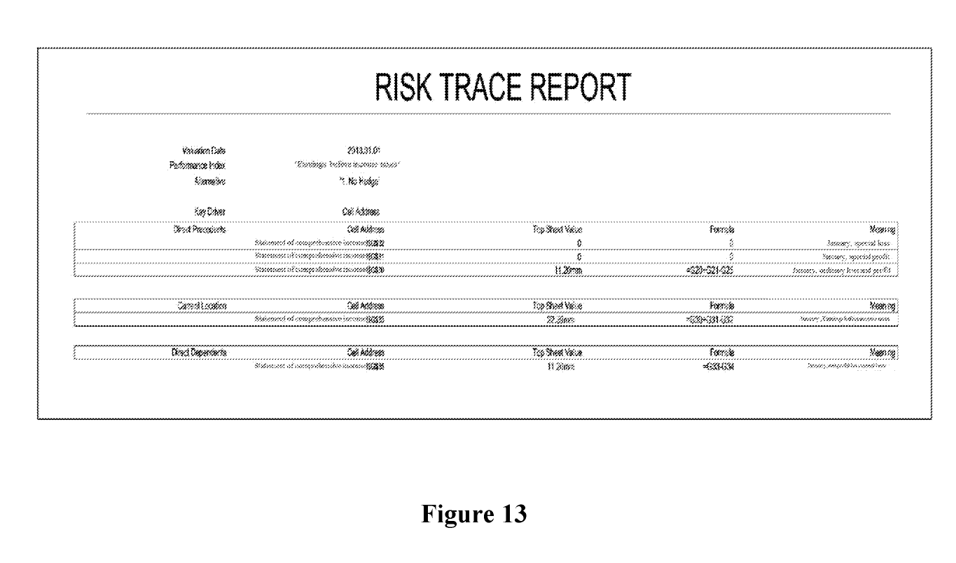

FIGS. 11 and 13 are views for describing a method for providing a risk trace information according to the present invention.

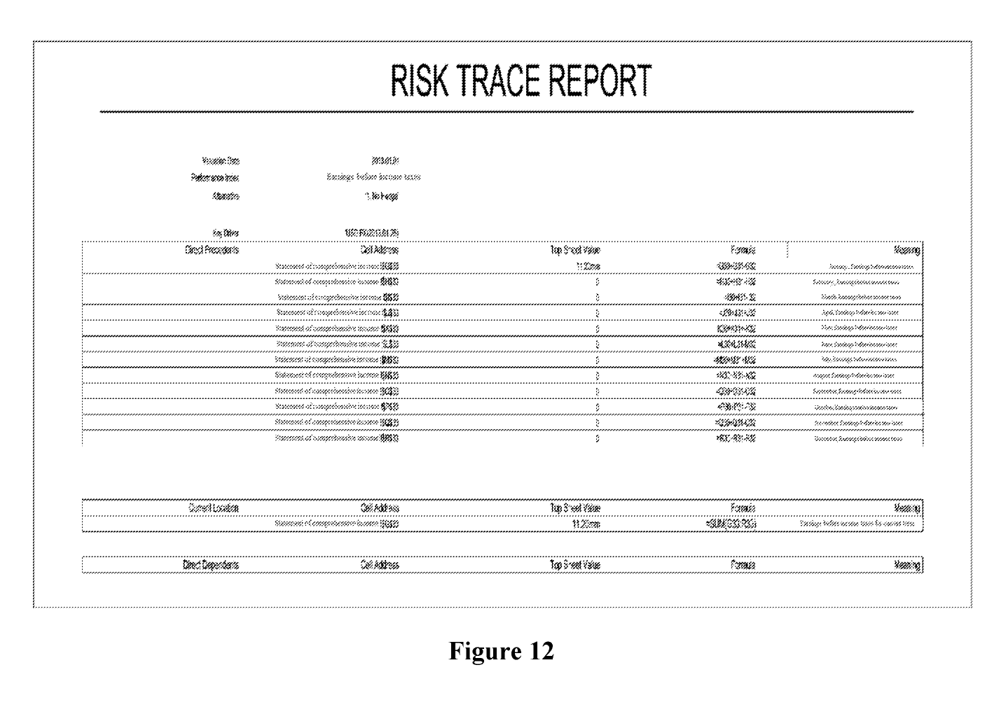

As illustrated in FIG. 11, if the value (the sell dollars 22,392,253.27) of a predetermined report (for example, a risk map) is selected by the manager, as illustrated in FIG. 12, there may be provided a risk trace information including a financial index (a net profit before a corporate tax and a cost are subtracted), and an index name (a net profit before a corporate tax and a cost are subtracted for January to December) of a sub-financial index which is used to calculate the financial index or as illustrated in FIG. 13, there may be provided a risk trace information including an index value and an internal exchange risk (11.20 mm), namely, a risk trace information including an exchange risk (11.20 mm) of a monthly sub-financial index (a special loss and profit, a special profit and an ordinary loss and profit in January) based on the index (a net profit before a corporate tax and a cost are subtracted) of the sub-financial index, whereupon the manager can easily understand various reports in such a way to confirm the contents or procedures wherein the values based on the financial index (the net profit before a corporate tax and a cost are subtracted=an ordinary loss and profit+a special profit—a special loss) has been calculated, and the manager can verify the data on a corresponding report.

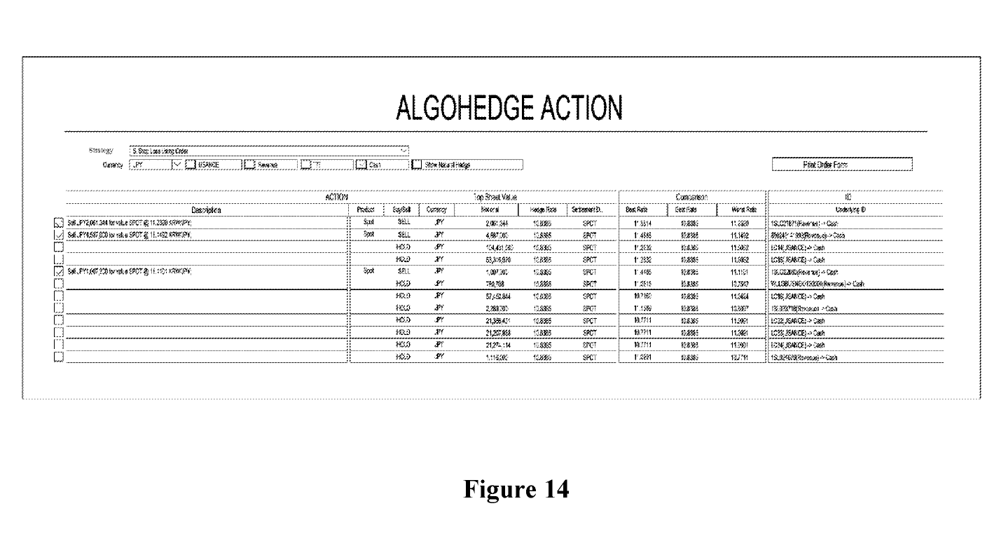

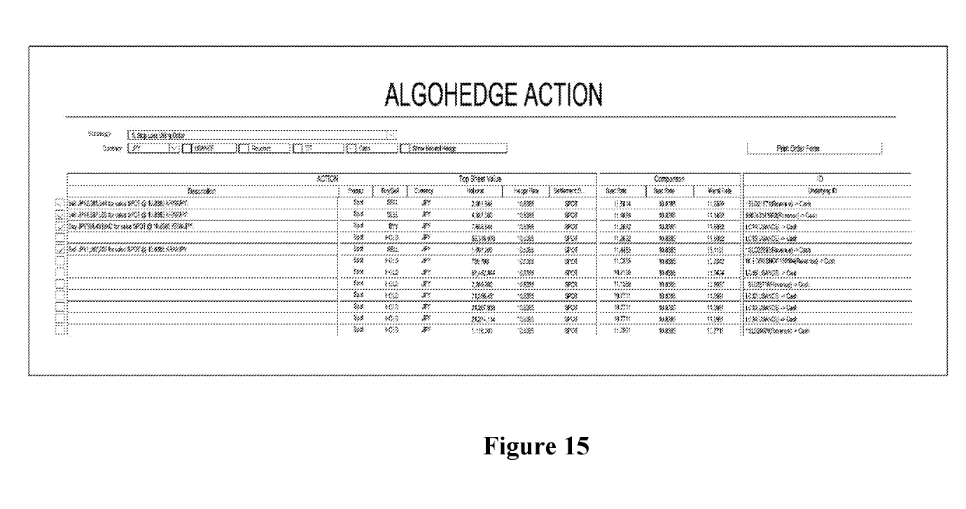

FIGS. 14 and 15 are views for describing a natural hedge function of a financial risk management device according to the present invention.

FIG. 14 shows that the financial risk management device 210 according to the present invention calculates the purchase based on the MTA. As illustrated in FIG. 15, if the manager selects the natural hedge (Show Natural Hedge), the financial risk management device 210 will display the amount which will be purchased later, and the trade can be offset by netting the purchase and the sell.

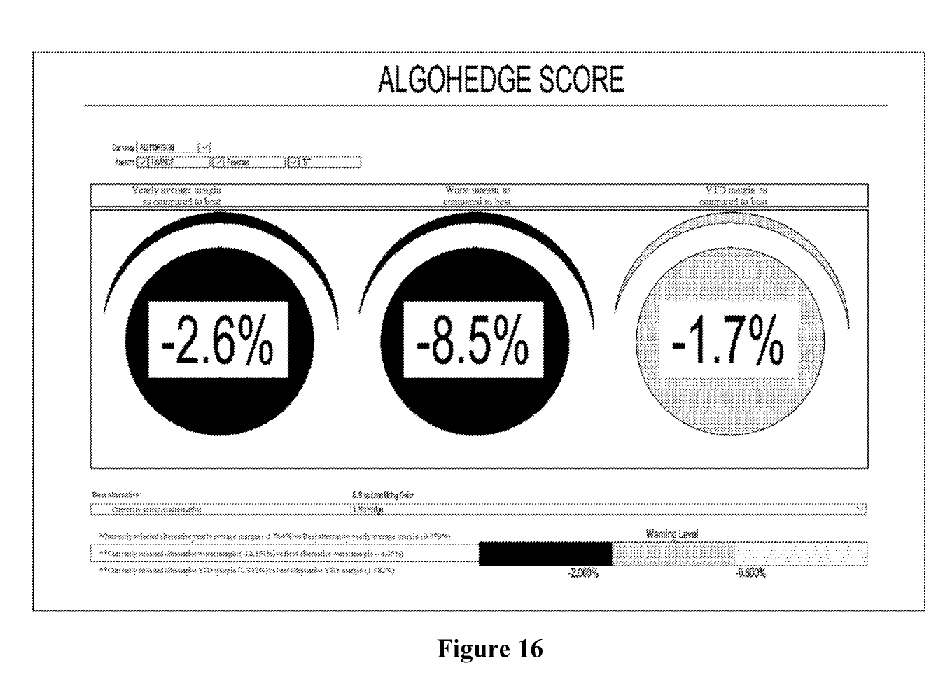

FIGS. 16 to 18 are views for describing a method for calculating a simulated trade information and an actual trade performance in the review step.

Referring to FIG. 16, reference number 1100 means a YTD (Year to Date) margin as compared to the Best wherein the Best alternative YTD margin is subtracted from the current selection alternative YTD margin, and 1200 means the Worst margin as compared to the Best wherein the Best alternative Worst margin is subtracted from the current selection alternative Worst margin, and 1300 means the yearly average margin as compared to the Best wherein the Best alternative yearly average margin is subtracted from the current selection alternative yearly average margin. Here, the current selection alternative is “1. No Hedge”, and the Best alternative is “5. Stop loss Using Order). Each margin may be indicated red, yellow, green, etc. based on the level of the risk.

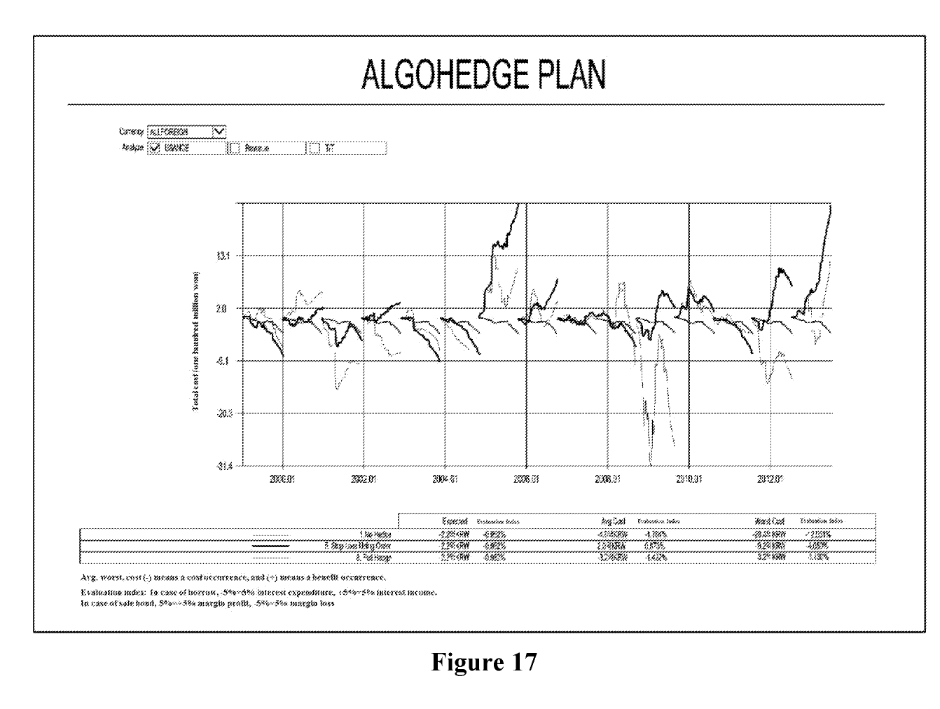

As illustrated in FIG. 17, the yearly average margin as compared to the Best means a value wherein the yearly average margin of the second RMA (5. Stop Loss Using Order) is subtracted from the yearly average margin (Avg. Cost) of the first RMA (1. No Hedge). Namely, about −2.6%, which is a yearly average margin as compared to the Best, can be calculated in such a way to subtract 0.873%, which is an yearly average margin of the second RMA, from −1.764% which is the yearly average margin of the first RMA.

As illustrated in FIG. 17, the Worst margin as compared to the Best means a value calculated by subtracting the Worst margin of the second RMA from the Worst margin (Worst cost) of the first RMA. More specifically, about −8.5%, which is the Worst margin as compared to the Best, can be obtained in such a way to subtract −4.050%, which is the Worst margin of the second MRA, from −12.551% which is the Worst margin of the first RMA.

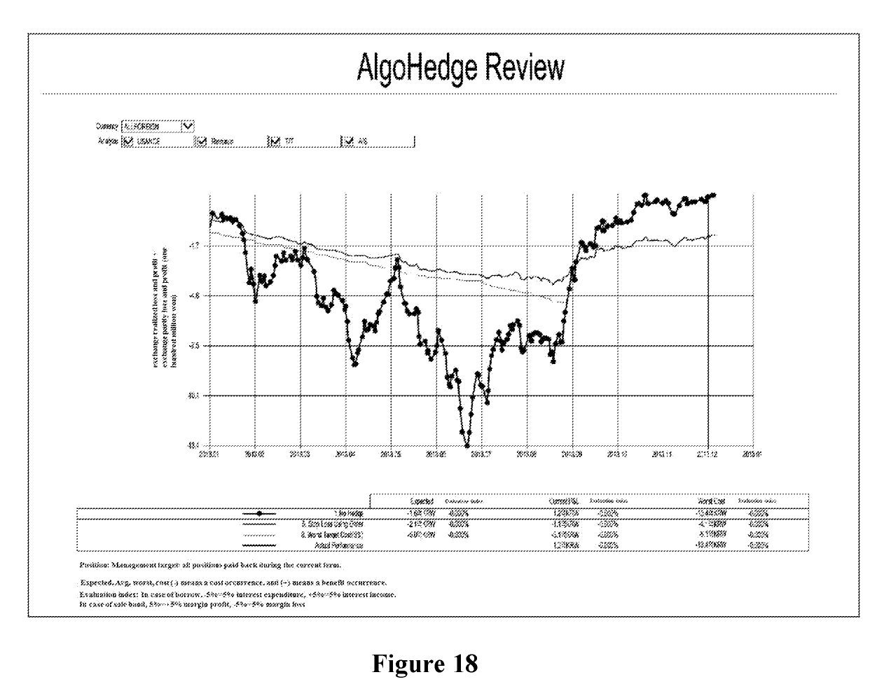

As illustrated in FIG. 18, the YTD margin as compared to the Best means a value calculated in such a way to subtract the current margin of the actual exchange loss and profit from the current margin of the first RMA. More specifically, about −1.7%, which is the YTD margin as compared to the Best, can be calculated in such a way to subtract 0.882% which is the current margin of the actual exchange loss and profit, from −0.805 which is the current margin of the first RMA.

In the financial risk management device 210 according to the present invention, the manager is able to evaluate the current trade plan based on the past history in such a way that a simulated trade performance information (the yearly average margin as compared to the Best, and the Worst margin as compared to the Best in FIG. 18) is calculated by accumulating the loss and profit from the past to the beginning of the year based on the selected RMA (the second RMA in FIG. 18), and an actual trade performance information (the YTD margin as compared to the Best in FIG. 18) is calculated by accumulating the loss and profit from the beginning of the year to the today, and then the simulated trade performance information and the actual trade performance information are provided.

As described above, the embodiments of the present invention have been described. The embodiments illustrated in the drawings should not be interpreted limited thereto, and a person having ordinary skill in the art who is familiar with the contents of the present invention may combine them, and in case of the combination, it is obvious that a part of the components may be omitted.

The terms or words used in the present specification and claims should not be interpreted limited to the typical or dictionary meanings, but be interpreted as meanings and concepts which match with the technical concepts of the present invention.

The components illustrated in the embodiments and drawings of the present invention are directed to an embodiment disclosed in the present invention, not representing all the technical concepts of the present invention, so it should be understood that there might be various equivalents and modifications which may substitute the above components at the time the present invention was filed.

### INDUSTRIAL APPLICABILITY

The present invention provides a method and apparatus for managing a financial risk which is providing a trade action, and a recording medium which is storing a program to execute the method wherein a hands-on worker of an enterprise is able to objectively and systematically manage a financial risk including an exchange risk and a raw material price fluctuation risk. If there is an input of a financial risk management policy including a financial statement, a current exchange risk management policy and a raw material price fluctuation risk management policy, a corresponding financial risk management policy can be reviewed by way of simulations, thus drawing a more appropriate financial management policy, and if the more appropriate financial risk management policy is drawn, an objective and systematic trade action can be provided based on the drawn financial risk management policy, and the present invention can guide that each enterprise should carry out what kind of a trade action so as to manage its own financial risk under a predetermined market situation whenever it needs and can inform why such a management plan is better than other management plans. In this way, the present invention can provide a method and apparatus which are able to go beyond any limit to the conventional technology, for which the uses of the related technologies as well as the sale of the apparatus or the business thereon will be available enough and will be actually carried out, which means that the present invention has a high industrial applicability.

1. An apparatus for managing a financial risk providing a trade action, comprising:
a storing unit which is configured to store a smart data including accounting constant information, and interrelationship information among the accounting information, and a plurality of risk management alternatives which are provided to set obtaining of a profit through a plurality of orders and a loss;
statistical information calculation unit which is able to calculate statistical information on any of an exchange loss cost, a raw material purchase cost, a debt ratio and a cash holding amount which correspond to each risk management alternative among a plurality of the risk management algorithms, by applying the smart data to a plurality of the risk management algorithms;
a RMA (Risk Management Algorithm) selection unit which is configured to select, by using the statistical information, a risk management algorithm which satisfies a condition wherein any of a maximum exchange loss cost, a maximum raw material purchase cost, a maximum debt ratio, and a minimum cash holding amount which are among a plurality of the risk management algorithms is within a predetermined range, and any of an average exchange loss cost, an average raw material purchase cost, an average debt ratio and an average cash holding amount is smallest;
a trade action calculation unit which is able to calculate a trade action including at least one of selling, purchasing, a holding, a trading time and amount in such a way to apply the smart data and a market information to the risk management algorithm selected by the RMA selection unit; and
a trade action execution unit which is able to execute a trade action by requesting to a financial institution server a process of the trade action calculated by the trade action calculation unit.

2. The apparatus of claim 1, further comprising:
a risk trace unit which is configured to provide a risk trace information including a financial index corresponding to a predetermined value of a predetermined report when the value thereof is selected based on a calculation of the statistical information or the calculation of the trade action, an index name of a sub-financial index used to calculate the financial index, and an internal financial risk level, wherein the financial index is an accounting constant or a value calculated using the accounting constant.

3. The apparatus of claim 1, wherein the trade action execution unit is configured to transmit to the financial institution server a contract information including a contract expiration date, a contract amount and a trade exchange, receive an exchange rate information on the trade exchange on the contract expiration date from the financial institution server, and request to the financial institution server a process of the trade action calculated by the trade action calculation unit with reference to the received exchange rate information.

4. The apparatus of claim 1, further comprising:
a risk HD (High Definition) unit which is configured to calculate the value of a predetermined report using a representative financial index table stored in the storing unit and an interrelationship between the smart data if the predetermined report is selected, which is provided based on a calculation of the statistical information or a calculation of the trade action.

5. The apparatus of claim 1, wherein the storing unit comprises:
a hedge table which is provided to store the trade content information received from the financial institution server via the trade action execution unit;
a planned position table which is provided to store an estimated financial statement information the amount and contract expiration date of which are uncertain; and an actual position table which is provided to store an actual financial statement information and amount, the kind of a maturity exchange the contract expirations of which are determined, and a standard financial statement information the contract expiration date is determined, which are among the estimated financial statement information stored in the planned position table.

6. The apparatus of claim 5, wherein the financial risk management device further comprises:
a table revolution unit wherein if the contract expiration date of the estimated financial statement information stored in the planned position table is determined, the information is converted into an actual financial statement information by assigning an ID to the estimated financial statement information, and the converted actual financial statement information is stored in the hedge table and the actual position table.

7. The apparatus of claim 1, further comprising:
a trade action review unit which is provided to calculate a simulated trade performance information by accumulating simulated loss and profit from the past to today based on a risk management algorithm selected by the RMA selection unit, calculate an actual trade performance information by accumulating actual loss and profit from the beginning of the year to today, and provide the calculated simulated trade performance information and actual trade performance information.

8. The apparatus of claim 1, wherein a plurality of the risk management algorithms comprise at least one of:
a first risk management algorithm wherein all the dollars are purchased at an exchange rate on the very date of the maturity date;
a second risk management algorithm wherein all the dollars are purchased on a corresponding date of the exchange rate is out of a previously set range; and a third risk management algorithm wherein all the dollars are purchased at an exchange rate on the very date on the borrowing date.

9. A method for managing a financial risk providing a trade action, comprising:
a step wherein a smart data including accounting constant information and interrelationship information among the accounting information, and a plurality of risk management algorithms to take a profit or define a loss via a plurality of orders are saved;
a step wherein statistical information on any of an exchange loss cost, a raw material purchase cost, a debt ratio and cash holding amount which correspond to each risk management algorithm among a plurality of the risk management algorithms by applying the smart data to each of a plurality of the risk management algorithms; and
a step wherein a risk management algorithm is selected using the statistical information, which satisfies a condition wherein any of a maximum exchange loss cost, a maximum raw material purchase cost, a maximum debt ratio and a minimum cash holding amount among a plurality of the risk management algorithms is within a previously set range, and any of an average exchange loss cost, an average raw material purchase cost, an average debt ratio and an average cash holding amount is smallest; and
a step wherein a trade action including at least one of selling, purchasing, holding, trading time and amount is calculated by applying the smart data and a market information to the selected risk management algorithm.

10. The method of claim 9, after the step for calculating the trade action, further comprising:
a step wherein a contract information including a contract expiration date, a contract amount and a trade exchange is transmitted to a financial institution server;
a step wherein an exchange rate information on the trade exchange on the contract expiration date is received from the financial institution server; and
a step wherein the trade action is executed by requesting a process of the calculated trade action to the financial institution server with reference to the received exchange rate information.

11. The method of claim 9, after the step for calculating the trade action, further comprising:
a step wherein a simulated trade performance information is calculated by accumulating simulated loss and profit from the past to today based on the selected risk management algorithm, and an actual trade performance information is calculated by accumulating actual loss and profit from the beginning of the year to today; and
a step wherein the calculated simulated trade performance information and the calculated actual trade performance information are provided.

12. A recording medium which is string a program to execute the method of claim 9.

13. A recording medium which is string a program to execute the method of claim 10.

14. A recording medium which is string a program to execute the method of claim 11.
